(19) United States
(12) Patent Application Publication
(10) Pub. No.: US 2005/0114627 A1
(43) Pub. Date: May 26, 2005

(54) Co-processing

(76) Inventors: Jacek Budny, Gdynia (PL); Gerard Wisniewski, Gdansk (PL)

Correspondence Address: FISH & RICHARDSON, PC, 12390 EL CAMINO REAL, SAN DIEGO, CA, 92130-2081, US

(21) Appl. No.: 10/723,454

(22) Filed: Nov. 26, 2003

(51) Int. Cl. G06F 15/00

(52) U.S. Cl. 712/34

(57) ABSTRACT

A method of co-processing includes connecting an interface of a first processor to an interface of a second is configurable to place the second processor in a slave processing mode or a master processing mode. The method also includes sending a task from the first processor to the second processor through the bus. The task includes an instruction that places the second processor in a slave processing mode.

### BACKGROUND

Typically processors are classified as high-end processors or low-end processors. High-end processors commonly have faster processing speed and/or more memory than low-end processors.

Processors include a number of interfaces to communicate with other external devices. One such interface is a Quad Data Rate (QDR) interface. The QDR interface is typically connected to a QDR static random access memory (SRAM). QDR SRAM is a high-performance communications memory standard for network switches, routers and other communication applications.

### DESCRIPTION OF THE DRAWINGS

FIG. 1 is a block diagram of a network processing system.

FIG. 2 is a block diagram of a co-processing system.

FIG. 3 is a flow diagram depicting processing in the co-processing system of FIG. 2.

FIG. 4 is a second example of a co-processing system.

FIG. 5 is a flow diagram depicting processing the co-processing system of FIG. 4.

FIG. 6 is a third example of a co-processing system.

FIG. 7 is a flow diagram depicting processing the co-processing system of FIG. 6.

### DESCRIPTION

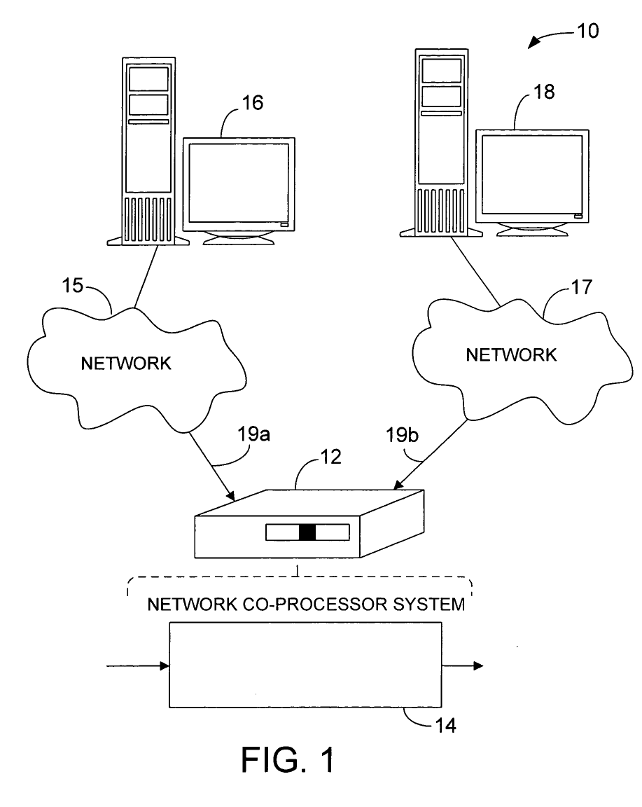

Referring to FIG. 1, a network system 10 includes a router 12 that has a co-processing system 14, a first network 15 (e.g., wide-area network (WAN), local-area network (LAN) and so forth) having a client 16, and a second network 17 having a client 18. Router 12, which is connected to first network 15 by line 19a and connected to network 17 by line 19b, allows client 16 and client 18 to communicate with each other. Typically, first network 15 is a different type of network than second network 17, for example, the first network is a WAN and the second network is a LAN. Router performs the required processing to ensure the data transfer is compatible for each network. Having co-processing system 14 instead of using a single processor increases the speed at which data is transferred between network 15 and network 17.

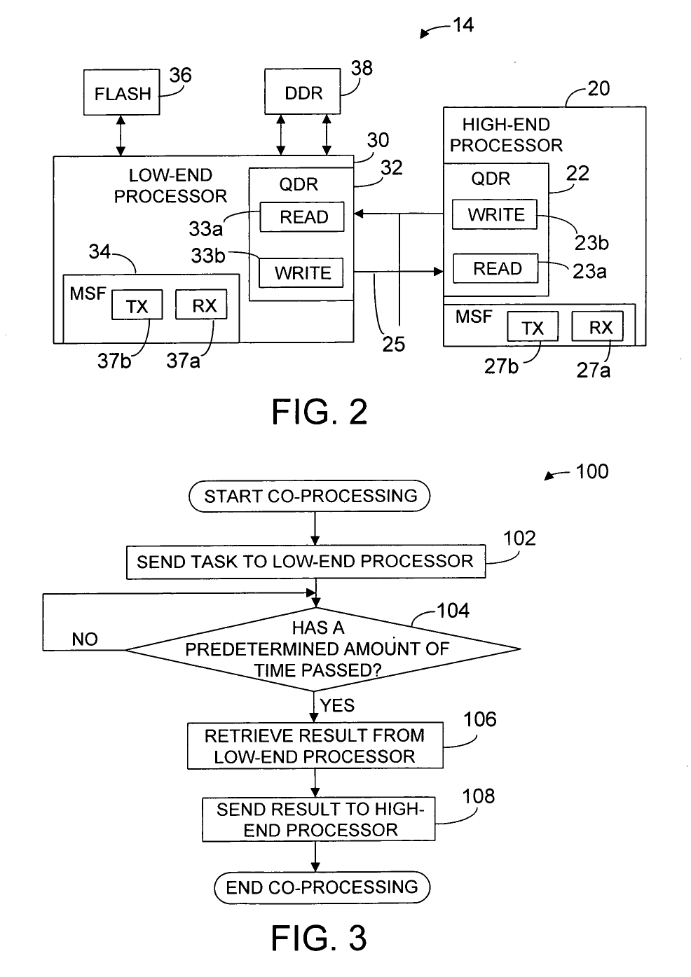

Referring to FIG. 2, co-processing system 14 includes a high-end processor 20 and a low-end processor 30 connected by a communications bus 25. High-end processor 22 includes a quad-data-rate (QDR) interface 22 and a media-switch-fabric (MSF) interface 24.

The QDR interface 22 is an interface configured to access memory, such as static random access memory (SRAM) or ternary content addressable memory (TCAM). QDR interface 22 includes a read port 23a and a write port 23b, which are independent ports. For example, read port 23a reads data simultaneously while write port 23b writes data at the same rate as the read port.

The MSF interface 24 is an interface configured to provide access to a physical layer device (not shown) and/or a switch fabric (not shown). The MSF interface 24 includes a receive port 27a and a transmit port 27b, which are unidirectional and independent of each other.

Low-end processor 30 includes a QDR interface 32, which includes a read port 33a and a write port 33b, and a MSF interface 34, which includes a receive port 37a and a transmit port 37b. As will be explained below, unlike other QDR interfaces to date, QDR interface 32 is configurable to place low-end processor 30 in a slave processing mode or a master processing mode. When the low-end processor 30 is in the slave processing mode, the low-end processor performs co-processing functions for the high-end processor.

A flash memory 36 and a double dual rate (DDR) synchronous dynamic random access memory (SDRAM) 38, a type of SDRAM that supports data transfers on both edges of each clock cycle (e.g., rising and falling edges), are connected to low-end processor 30. Bus 25 connects low-end processor 30 to high-end processor 20 by coupling their respective QDR interfaces 22 and 32. For example, communications bus 25 connects write port 23b to read port 33a and connects read port 23a to write port 33b.

The QDR interfaces and the MSF interfaces facilitate co-processing functionality. Thus, rather than designing application-specific integrated circuits (ASICs) to perform co-processing for the high-end processors, low-end processors, which are less expensive than ASICs, may be connected to the high-end processor to perform co-processing functions.

By connecting communications bus 25 between QDR interface 22 and QDR interface 32, high-end processor 20 uses the resources available to low-end processor 30, such as processing capacity, flash memory 36 and DDR SDRAM memory 38, to process data more efficiently and faster than using the high-end processor alone.

QDR interface 32 is configured to support high-end processor 20 when it performs in a master processor mode (i.e., giving a task to low-end processor 30 to process); and is configured to support the low-end processor when it performs in a slave processor mode (i.e., processing the task received from the high-end processor). For example, when high-end processor 20 is in the master processing mode and low-end processor 30 is in the slave processing mode, the high-end processor sends a task to the low-end processor to execute using the low-end processor's available resources.

QDR interface 32 also supports low-end processor 30 when it is in the master processor mode (i.e., sending a result of the task (e.g., data) back to high-end processor 20 or sending a task to the high-end processor to execute). For example, when low-end processor 20 is in the master processing mode, the low-end processor sends the result from processing the task back to high-end processor 20.

A task in this description includes one or more instructions, memory referencing, and the like, or any combination thereof. The task may come from any source using high-end processor 20 including an application resident on or off the high-end processor.

Bus 12 supports each processor being in a master processing mode simultaneously since the connection between read port 33a and write port 23b port is independent from the connection between write port 33b and read port 23a.

Referring to FIG. 3, an exemplary process 100 for performing co-processing between high-end processor 20 and low-end processor 30 in system 14 is shown. Process 100 sends (102) a task from high-end processor 20 to low-end processor 30 through communications bus 12. For example, high-end processor 20 may not currently have the capacity to process the task so it allocates the task to low-end processor 30 to execute. In another example, the task is sent from write port 23b to read port 33a. Process 100 determines (104) if a predetermined amount of time has passed. The predetermined amount of time may be equal or greater than the amount of time required for low-end processor 30 to execute the task. After the predetermined amount of time has passed, process 100 retrieves (106) the result from the low-end processor 30 and process 100 sends (108) the result of the task to high-end processor 20. For example, the result is retrieved from DDR SDRAM memory 38 and sent from write port 33b to read port 23a.

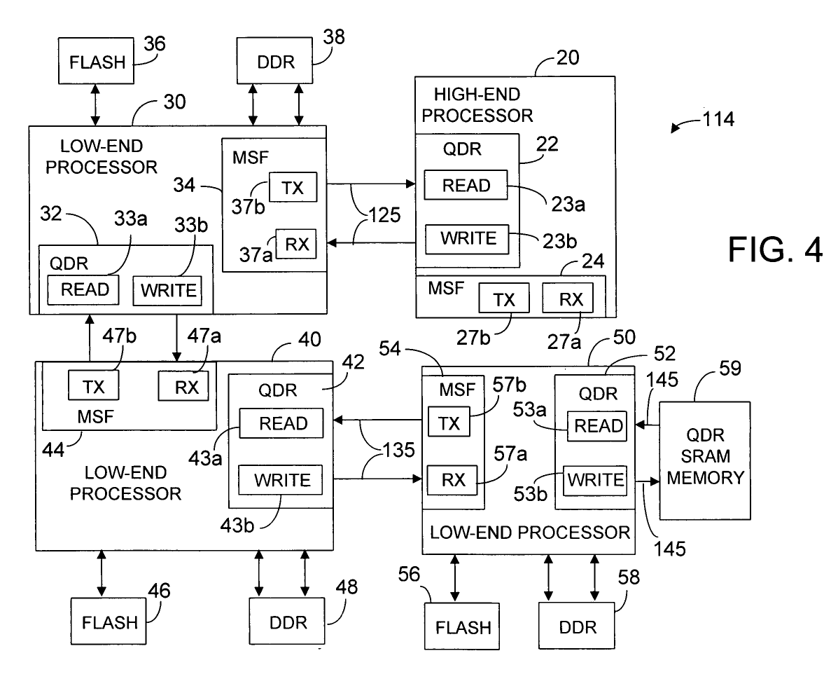

Referring to FIG. 4, a co-processing system 114 includes high-end processor 20 and three low-end processors (e.g., low-end processor 30, a low-end processor 40 and a low-end processor 50) in a chain configuration. Low-end processor 40 includes a QDR interface 42 with a read port 43a and write port 43b and a MSF interface 44 with a receive port 47a and a transmit 47b. A flash memory 46 and a DDR SDRAM memory 48 are connected to low-end processor 40.

Low-end processor 50 includes a QDR interface 52 with a read port 53a and write port 53b, and a MSF interface 54 with a receive port 57a and a transmit port 57b. A flash memory 56 and a DDR SDRAM memory 58 are connected to low-end processor 50. A QDR SRAM memory 59 is connected to QDR interface 52 through a communications bus 145.

High-end processor 20 is connected to low-end processor 30 by connecting QDR interface 22 to MSF interface 34 through a communication bus 125. In particular, write port 23b is connected to receive port 37a and read port 23a is connected to transmit port 37b.

A low-end processor 30 is connected to low-end processor 40 by connecting a communications bus 130 from QDR interface 32 to a MSF interface 44 of low-end processor 40. In particular, read port 33a is connected to transmit port 47b and write port 33b is connected receive port 47a.

A low-end processor 40 is connected to low-end processor 50 by connecting a communications bus 134 from QDR interface 42 to a MSF interface 54 of low-end processor 50. In particular, read port 43a is connected to transmit port 57b and write port 43b is connected to receive port 57a.

Buses 125, 130 and 135 support each processor being in a master processing mode simultaneously with one another since the connection between the read ports and the transmit ports of each bus are independent from the connections between the write ports and the receive ports.

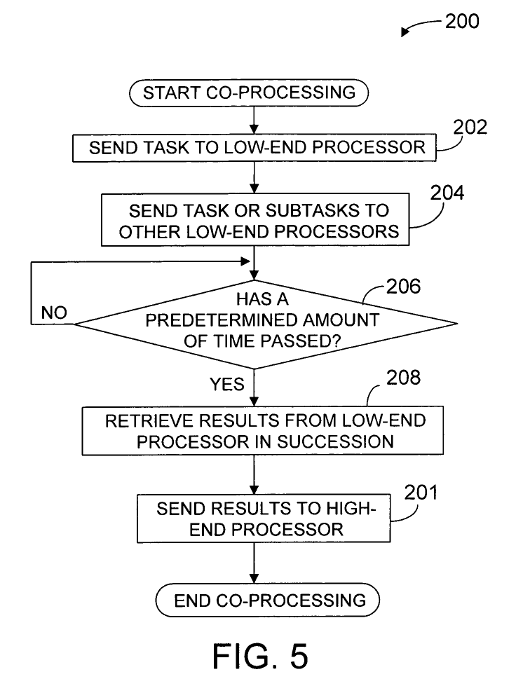

Referring to FIG. 5, a process 200 for performing co-processing over co-processing system 114 is shown. Process 200 allows co-processing amongst a chain of low-end processors. For example, a task may be passed through the chain of processors to be executed by one or more of the low-end processors 30, 40 and 50, and sent back to high-end processor 20.

Process 200 sends (202) a task through communications bus 125 from high-end processor 20 to low-end processor 30 for execution. For example, the task is sent from read port 23a of high-end processor 20 to receive port 37a of low-end processor 30. Process 200 sends (204) the task or a subtask to subsequent low-end processors 40 and 50 to execute. For example, low-end processor sends a task or subtask from read port 33a of QDR interface 32 to receive port 47b of MSF interface 44.

In some situations, low-end processor 30 does not have the capacity to perform the task so the task is sent to low-end processor 40. In other situations, low-end processor may have the capacity to perform only a portion of the task so that the portions of the task that it cannot process are sent to low-end processor 40 in the form of subtasks. For example, low-end processor 30 may send a task to low-end processor 40, and low-end processor 40 determines what part of the task will be performed at low-end-processor 40 and what part of the task will be executed by low-end processor 50.

Process 200 determines (206) if a predetermined amount of time has passed. The predetermined amount of time may be equal or greater than the amount of time required for low-end processors 30, 40 and 50 to execute the task including its subtasks. If the predetermined amount of time has passed, process 200 retrieves (208) results from low-end processors 30, 40, and 50.

Process 200 sends (210) the results to high-end processor 20. For example, each low-end processor result is sent to high-end processor one processor at a time. First, low-end processor 50 sends the result it calculated based on a task or subtask to low-end processor 40, and low-end processor 40 sends the result from low-end processor 50 to low-end processor 30. Low-end processor 30 sends the result from low-end processor 50 to high-end processor 20. Second, low-end processor 40 sends the result it calculated to low-end processor 30 and low-end processor 30 sends the result from low-end processor 40 to high-end processor 20. Finally, low-end processor 30 send its result to high-end processor 20.

In another example, as each result is sent up the chain it is combined with each processor's result and a combined result is sent to high-end processor 320. In particular, the result from low-end processor 50 is sent to low-end processor 40. The result from low-end processor 40 is combined with the result from low-end processor 50 and the combined result is sent to low-end processor 30. Processor 30 sends the combined result and the result calculated by low-end processor 30 to low-end processor 20.

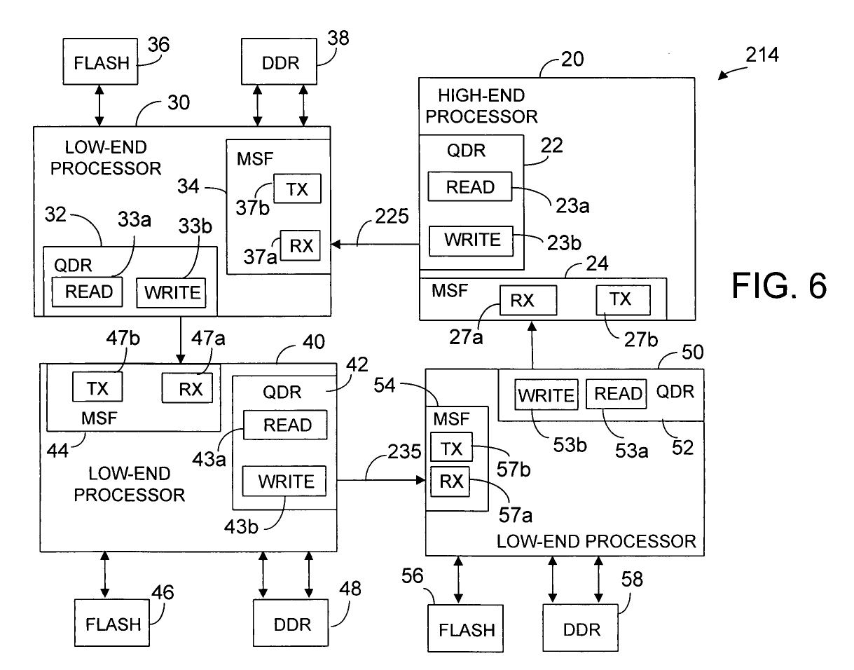

Referring to FIG. 6, another example of a co-processing system is a co-processing system 214, which is similar to co-processing system 114 except low-end processor 50 is coupled to high-end processor 20 to complete a processing loop. In particular, a bus 240 connects write port 53b to receive port 27a of MSF interface 24.

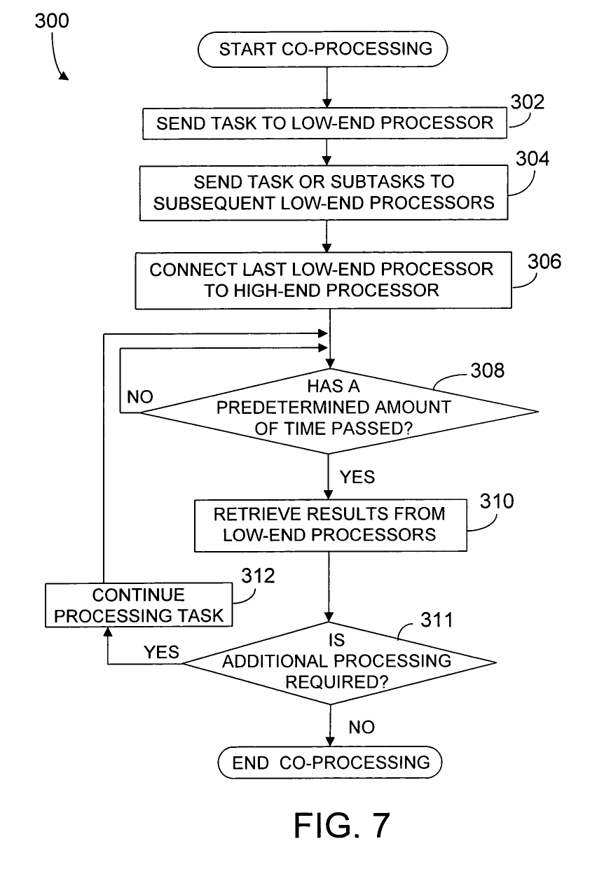

Referring to FIG. 7, a process 300 is an example of co-processing in a co-processing system 214. Process 300 sends a task (302) to low-end processor 30 for execution. Process 300 sends (304) the task or subtasks to low-end processors 40 and 50. For example, low-end processor 30 determines that it cannot execute the task efficiently alone so the low-end processor 30 sends all or part the task to low-end processor 40. Processor 40 determines that it cannot execute all or some of the task sent from low-end processor 30 and sends all or part of the remaining task to low-end processor 50.

Process 300 determines (308) if a predetermined amount of processing time has passed. The predetermined amount of time may be equal or greater than the amount of time required for low-end processors 30, 40 and 50 to execute the task including its subtasks. In other embodiments, the predetermined time may be less than the time required for the low-end processors to complete a task. For example, the predetermined time is equal to the time required by one low-end processor to complete a task. In another example, the predetermined amount of time is equal to the time a low-end processor completes a subtask.

Process 300 retrieves (310) the results from low-end processors 30, 40 and 50. For example, low-end processor 30 sends the result of its processing to high-end processor 20 by sending the result to low-end processor 40 through communications bus 230, to low-end processor 50 through communications bus 235 and through communications bus 240. Low-end processor 40 sends its result to high-end processor 40 by sending its result to low-end processor 50 through communications bus 235 through communications bus 240. Low-end processor 50 sends its result to high-end processor 20 through communications bus 240.

Process 300 determines (312) if additional processing is required. If additional processing is required, process 300 continues processing the task.

The processes described herein can be implemented in digital electronic circuitry, or in computer hardware, firmware, software, or in combinations of them. The processes described herein can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods can be performed by one or more programmable processors executing a computer program to perform functions of the invention by operating on input data and generating output. The method can also be performed by, and apparatus of the invention can be implemented as, special purpose logic circuitry, e.g., an FPGA (field programmable gate array) or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The processes described herein can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The processes described herein can also be implemented in other electronic devices individually or in combination with a computer or computer system. For example, the processes can be implemented on mobile devices (e.g., cellular phones, personal digital assistants, etc.).

The processes described herein are not limited to the specific processing order. Rather, the blocks of FIGS. 3, 5 an 7 may be re-ordered, combined or eliminated, as necessary, to achieve the results set forth above. In another example, co-processing system 114 may have n (n>2) low-end processors in the chain of processors. In another example, co-processing system 214 may have n (n>2) low-end processors in the loop of processors.

The embodiments herein are not limited to co-processing in a network system or network processors. Rather, the other embodiments may include any system using a processor.

The invention has been described in terms of particular embodiments. Other embodiments not described herein are also within the scope of the following claims.

1. A method of co-processing, comprising:
connecting an interface of a first processor to an interface of a second processor using a bus, the interface of the second processor being configurable to place the second processor in a slave processing mode or a master processing mode; and
sending a task from the first processor to the second processor through the bus, the task comprises an instruction that places the second processor in a slave processing mode.

2. The method of claim 1, wherein the task further comprises an instruction that places the second processor in a master processing mode.

3. The method of claim 1, further comprising:
sending data from the second processor to the first processor based on the task received from the first processor

4. The method of claim 1, wherein the interface of the first processor includes a first quad data rate (QDR) interface and the interface of the second processor includes a second QDR interface.

5. The method of claim 1, wherein the interface of the first processor includes a first quad data rate (QDR) interface and the interface of the second processor includes a first media switch fabric (MSF) interface.

6. The method of claim 5, further comprising connecting a second QDR interface of the second processor to a second MSF interface of a third processor using a second bus.

7. The method of claim 6, wherein the first, second and third processors are processors in a plurality of processors and the method further comprises:
connecting the plurality of processors successively in a chain with the first processor at one end of the chain and a last processor at the opposite end of the chain from the first processor, each of the plurality processors having an MSF interface and a QDR interface; and
connecting the QDR interface of the last processor to an external memory.

8. The method of claim 7, further comprising:
sending a task from a first processor to the last processor;
executing the task; and
sending a result to the first processor.

9. The method of claim 6, wherein the first, second and third processors are processors in a plurality of processors and the method further comprises:
connecting the plurality of processors successively in a chain with the first processor at one end of the chain and a last processor at the opposite end of the chain from the first processor, each of the plurality processors having an MSF interface and a QDR interface; and
connecting the QDR interface of the last processor to the MSF interface of the first processor.

10. The method of claim 9, further comprising:
sending instructions from the first processor to the last processor;
executing the instructions; and
sending a result to the first processor.

11. The method of claim 1, wherein the first processor has a first processing speed and the second processor has a second processing speed, the first processing speed is greater than the second processing speed.

12. An apparatus comprising:
a first processor having an interface connected to an interface of a second processor using a bus, the interface of the first processor being configurable to place the first processor in a slave processing mode or a master processing mode; and
circuitry, for co-processing, to:
receive a task from the second through the bus, the task comprises an instruction that places the first processor in a slave processing mode.

13. The apparatus of claim 12, wherein the task further comprises an instruction that places the first processor in a master processing mode.

14. The apparatus of claim 12, further comprising circuitry to:
send data from the first processor to the second processor based on the task received from the second processor.

15. The apparatus of claim 12 wherein the interface of the first processor includes a quad data rate (QDR) interface and the interface of the second processor includes a QDR interface.

16. The apparatus of claim 12, wherein the interface of the second processor includes a quad data rate (QDR) interface and the interface of the first processor includes a media switch fabric (MSF) interface.

17. The apparatus of claim 16, wherein a QDR interface of the first processor is connected to a MSF interface of a third processor using a second bus.

18. The apparatus of claim 17, wherein the first, second and third processors are processors in a plurality of processors successively coupled in a chain with the first processor at one end of the chain and a last processor at the opposite end of the chain from the first processor, each of the plurality processors having an MSF interface and a QDR interface, the QDR interface of the last processor is connected to an external memory.

19. The apparatus of claim 18, further comprising circuitry to:
send a task from the second processor to the last processor;
execute the task; and
send a result to the second processor.

20. The apparatus of claim 17, wherein the first, second and third processors are processors in a plurality of processors successively coupled in a chain with the first processor at one end of the chain and a last processor at the opposite end of the chain from the first processor, each of the plurality processors having an MSF interface and a QDR interface, the QDR interface of the last processor is connected to the MSF interface of the second processor.

21. The apparatus of claim 20, further comprising circuitry to:
send instructions from the second processor to the last processor;
execute the instructions; and
send a result to the second processor.

22. An article comprising a machine-readable medium that stores executable instructions for co-processing, the instructions causing a machine to:
send a task from an interface of a first processor to an interface of a second processor through a bus, the interface of the second processor being configurable to place the second processor in a slave processing mode or a master processing mode, the task comprises an instruction that places the second processor in a slave processing mode.

23. The article of claim 22, wherein the task further comprises an instruction that places the second processor in a master processing mode.

24. The article of claim 22, further comprising instructions causing a machine to:
send data from the second processor to the first processor based on the task received from the first processor

25. The article of claim 22 wherein the interface of the first processor includes a first quad data rate (QDR) interface and the interface of the second processor includes a second QDR interface.

26. The article of claim 22, wherein the interface of the first processor includes a first quad data rate (QDR) interface and the interface of the second processor includes a first media switch fabric (MSF) interface.

27. The article of claim 26, wherein a QDR interface of the second processor is connected to an MSF interface of a third processor using a second bus.

28. The article of claim 27, wherein the first, second and third processors are processors in a plurality of processors successively coupled in a chain with the first processor at one end of the chain and a last processor at the opposite end of the chain from the first processor, each of the plurality processors having an MSF interface and a QDR interface, the QDR interface of the last processor is connected to an external memory.

29. The apparatus of claim 28, further comprising instructions causing a machine to:
send a task from a first processor to the last processor;
execute the task; and
send a result to the first processor.

30. The method of claim 27, wherein the first, second and third processors are processors in a plurality of processors successively coupled in a chain with the first processor at one end of the chain and a last processor at the opposite end of the chain from the first processor, each of the plurality processors having an MSF interface and a QDR interface, the QDR interface of the last processor is connected to the MSF interface of the second processor.

31. The method of claim 30, further comprising instructions causing a machine to:
send instructions from the first processor to the last processor;
execute the instructions; and
send a result to the first processor.

32. A network router, comprising:
a network co-processing system, the network co-processing system comprising:
a first processor having an interface; and
a second processor having an interface connected to the interface of the first processor by a bus, the interface of the second processor being configurable to place the second processor in a slave processing mode or a master processing mode.
an input line connecting the network co-processing system to a first network; and
an output line connecting the network co-processing system to a second network.

33. The router of claim 32 wherein the interface of the first processor includes a first quad data rate (QDR) interface and the interface of the second processor includes a second QDR interface.

34. The router of claim 32, wherein the interface of the first processor includes a first quad data rate (QDR) interface and the interface of the second processor includes a media switch fabric (MSF) interface.

35. The router of claim 34, wherein a QDR interface of the second processor is connected to a MSF interface of a third processor using a second bus.
